(19) United States
(12) Patent Application Publication
(10) Pub. No.: US 2023/0142287 A1
(43) Pub. Date: May 11, 2023

(54) LATTICE ANCHORS FOR 3D OBJECTS

(71) Applicant: HEWLETT-PACKARD DEVELOPMENT COMPANY, L.P., Spring, TX (US)

(72) Inventors: Aja Hartman, Palo Alto, CA (US); Michelle Niu, Palo Alto, CA (US)

(73) Assignee: HEWLETT-PACKARD DEVELOPMENT COMPANY, L.P., Spring, TX (US)

(21) Appl. No.: 17/523,234

(22) Filed: Nov. 10, 2021

(51) Int. Cl. B29C 64/153; B29C 64/20; B29C 64/40; B29C 64/393; B33Y 10/00; B33Y 50/02; B33Y 70/00

(52) U.S. Cl. CPC B29C 64/153; B29C 64/20; B29C 64/40; B29C 64/393; B33Y 10/00; B33Y 50/02; B33Y 70/00; B29K 2023/12

(57) ABSTRACT

In one example in accordance with the present disclosure, a method is described. The example method includes forming a lattice anchor with a build material in a powder bed of a three-dimensional (3D) printing system. The example method also includes forming a 3D object with the build material attached to the lattice anchor.

### BACKGROUND

Three-dimensional (3D) printing is an additive printing process used to make three-dimensional solid parts from a digital model. 3D printing is often used in rapid product prototyping, mold generation, mold master generation, and short run manufacturing. Some 3D printing techniques are considered additive processes because they involve the application of successive layers of material. This is unlike other machining processes, which often rely upon the removal of material to create the final part. 3D printing may involve curing or fusing of the building material, which for some materials may be accomplished using melting or sintering, and for other materials may be accomplished using digital light projection technology.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a three-dimensional (3D) printing system to form a lattice anchor for a 3D object, according to an example.

FIG. 2 illustrates a lattice anchor attached to a 3D object, according to an example.

FIG. 3 is a flow diagram illustrating a method for forming a lattice anchor for a 3D object, according to an example.

FIG. 4 is a flow diagram illustrating a method for designing a lattice anchor for a 3D object, according to an example.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

The present disclosure is drawn to three-dimensional (3D) printing systems and methods. More particularly, the systems and methods can be used with powder bed fusion (PBF) where a heat source (e.g., a thermal print head, laser, etc.) is used to consolidate a powdered build material to form a 3D object. In some examples, the heat source may be applied to the build material contained within a powder bed to form a layer of the 3D object. Examples of PBF include multi-jet fusion (MJF), and laser sintering.

In the case of MJF, to form the 3D printed object, a polymer build material (particulate or powder) is spread on a powder bed support (referred to herein as a build area platform) on a layer-by-layer basis. Jetting fluid(s), including a fusing agent, can be selectively ejected from a print head, such as a fluid ejector similar to an inkjet print head, for example, and then the layer can be exposed to electromagnetic radiation to fuse select portions of the layer of the build material. This can be repeated layer by layer until a three-dimensional object is formed.

In examples of laser sintering, a laser or electron beam may be used to selectively melt and sinter build material together at specific points. Once a layer of the 3D object is completed, the build area platform lowers and more build material is distributed on the top of the powder bed for a subsequent layer.

In some examples, a 3D printing system may include a build material distributor to distribute build material in the powder bed. For example, a build material distributor may push build material onto the build area platform to form a layer of the build material. In some examples, the build material distributor may be a roller, a blade (e.g., a doctor blade), a combination of a roller and a blade, and/or any other device capable of spreading the build material over the build area platform. For instance, the build material distributor may be a counterrotating roller.

In some cases, the build material may exhibit a tendency to adhere to the build material distributor. For example, the temperature of the build material when the build material is spread on the powder bed may be the melting temperature of the build material. In this case, the temperature of the fused build material may be hot enough to cause the build material to stick to the build material distributor. For instance, with some types of build materials, the fused build material may stick to a roller (or other build material distributor) as the roller spreads the build material in a layer of the powder bed.

This condition of the fused build material bonding to the build material distributor may become more pronounced when build material is applied over a region of the powder bed that was previously melted to form a 3D object. For example, fused powder of the top layer of the 3D object may stick to the build material distributor when the build material distributor is in the process of recoating the next layer of the 3D object. In this case, the residual heat of a prior layer's melt pool may heat the fused build material, thus causing the build material to reach a temperature where the fused build material starts to adhere to the build material distributor. Furthermore, the larger the surface area of 3D object relative to the build material distributor, the more likely the fused build material is to stick to the build material distributor due to the heat emitted by the melt pool of the 3D object. Thus, 3D objects with a high cross-sectional layer surface area may tend to stick to the build material distributor.

Negative effects may occur when the fused build material sticks to the build material distributor. For example, a 3D object may become warped as regions of the build material stick to the build material distributor. In another example, layers of build material may fail to bond correctly if the build material pulls away from a lower layer. In yet another example, the build material distributor may push the 3D object out of place if the build material bonds to the build material distributor. In some examples, the build material distributor may even push the 3D object out of the powder bed, which may result in a complete print failure and may damage the 3D printing system.

The present disclosure is related to creating large surface area 3D objects using build materials that exhibit a tendency to stick to the build material distributor. An example of a build material that tends to stick to a build material distributor is polypropylene powder. It should be noted that other polymers may have similar tendencies to stick to a build material distributor.

In some examples, a lattice anchor may be used to counter the force exerted by the build material sticking to the build material distributor. For example, a lattice structure may be formed below the 3D object in the powder bed. The lattice structure may have a low cross-sectional layer surface area, thus avoiding getting stuck to the build material distributor. The lattice anchor may have a number of openings that trap powdered build material. This trapped build material may resist movement of the lattice anchor within the powder bed. By printing the lattice anchor at a depth in the powder bed below the 3D object, the lattice anchor acts as an anchor for a later-printed 3D object with a large cross-sectional layer surface area. Without this lattice anchor, the 3D object would likely stick to the build material distributor and may move. This movement may result in a failure of the 3D printing process, or may result in a flawed 3D object.

The present specification describes examples of a method. The example method includes forming a lattice anchor with a build material in a powder bed of a 3D printing system. The example method also includes forming a 3D object with the build material attached to the lattice anchor.

In another example, the present specification describes another example method that includes generating a combined model that combines the lattice anchor model and a 3D object model. The example method also includes forming the lattice anchor and 3D object with a build material in a powder bed of a 3D printing system based on the combined model.

In yet another example, the present specification also describes a 3D printing system. In some examples, the 3D printing system includes a build material distributor, a controller, and a non-transitory computer readable medium having stored thereon computer executable instructions to cause the controller to utilize the build material distributor to dispense the build material to form a lattice anchor. The instructions also cause the controller to utilize the build material distributor to dispense the build material to form a 3D object attached to the lattice anchor, the lattice anchor and 3D object being formed in a plurality of layers.

As used in the present specification and in the appended claims, the term “controller” may be a processor resource, a processor, an application-specific integrated circuit (ASIC), a semiconductor-based microprocessor, a central processing unit (CPU), and a field-programmable gate array (FPGA), and/or other hardware device that executes instructions.

As used in the present specification and in the appended claims, the term “memory” may include a non-transitory computer-readable storage medium, where the computer-readable storage medium may contain, or store computer-usable program code for use by or in connection with an instruction execution system, apparatus, or device. The memory may take many types of memory including volatile memory (e.g., RAM) and non-volatile memory (e.g., ROM).

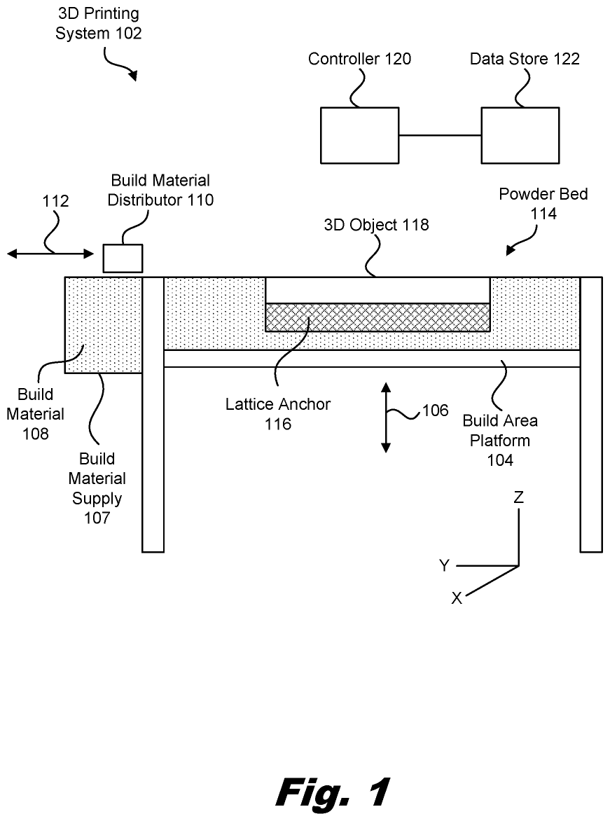

Turning now to the figures, FIG. 1 is a block diagram of a 3D printing system 102 to form a lattice anchor 116 fora 3D object 118, according to an example. It is to be understood that the 3D printing system 102 may include additional components and that some of the components described herein may be removed and/or modified. Furthermore, components of the 3D printing system 102 depicted in FIG. 1 may not be drawn to scale and thus, the 3D printing system 102 may have a different size and/or configuration other than as shown therein.

The 3D printing system 102 includes a build area platform 104, a build material supply 107 containing build material 108, and a build material distributor 110. In some examples, the build material 108 may be a polypropylene powder. As discussed above, polypropylene powder tends to stick to the build material distributor 110. While the example of polypropylene powder is described, other materials may be used for the build material 108. For example, the build material 108 may include thermoplastic polyamide (TPA).

In some examples, while the 3D object 118 made of fused build material 108 may tend to stick to the build material distributor 110, the build material 108 may be selected for use in the 3D object 118 based on a variety of properties. For example, a build material 108 may be selected for recyclability, optical properties, skin-to-skin contactable properties, strength, flexibility, electrical conductivity, etc. Thus, a given material may be selected for the build material 108 despite the tendency of the build material 108 to stick to the build material distributor 110.

The build area platform 104 receives the build material 108 from the build material supply 107. The build area platform 104 may be integrated with the 3D printing system 102 or may be a component that is separately insertable into the 3D printing system 102. For example, the build area platform 104 may be a module that is available separately from the 3D printing system 102. The build material platform 104 that is shown is also one example, and could be replaced with another support member, such as a platen, a fabrication/print bed, a glass plate, or another build surface.

The build area platform 104 may be moved in a direction as denoted by the arrow 106, e.g., along the z-axis, so that build material 108 may be delivered to the build area platform 104 or to a previously formed 3D object layer (i.e., fused build material). In an example, when the build material 108 is to be delivered, the build area platform 104 may be programmed to advance (e.g., downward) enough so that the build material distributor 110 can push the build material 108 onto the build area platform 104 to form a layer of the build material 108 thereon. The build area platform 104 may also be returned to its original position, for example, when a new 3D object 118 is to be built.

The build material supply 107 may be a container, bed, or other surface that is to position the build material 108 between the build material distributor 110 and the build area platform 104. In some examples, the build material supply 107 may include a surface upon which the build material 108 may be supplied, for instance, from a build material source (not shown) located above the build material supply 107. Examples of the build material source may include a hopper, an auger convey er, or the like. In some examples, the build material supply 107 may include a mechanism (e.g., a delivery piston) to provide, e.g., move, the build material 108 from a storage location to a position to be spread onto the build area platform 104 or onto a previously formed 3D object layer.

The build material distributor 110 may be moved in a direction as denoted by the arrow 112, e.g., along the y-axis, over the build material supply 107 and across the build area platform 104 to spread a layer of the build material 108 over the build area platform 104. The build material distributor 110 may also be returned to a position adjacent to the build material supply 107 following the spreading of the build material 108. In some examples, the build material distributor 110 may be a blade (e.g., a doctor blade), a roller, a combination of a roller and a blade, and/or any other device capable of spreading the build material 108 over the build area platform 104. For instance, the build material distributor 110 may be a counterrotating roller.

In some examples, the 3D printing system 102 may include an applicator (not shown) for dispensing an agent (e.g., a fusing agent, a detailing agent, a plasticizer agent, a pore promoting agent, etc.). As examples, the applicator may be a thermal inkjet printhead or print bar, a piezoelectric printhead or print bar, or a continuous inkjet printhead or print bar. In another example, the 3D printing system 102 includes one applicator for all of the agents being used in the method. In this example, the applicator may be a single printhead or print bar, which includes a separate fluid slot and fluidics for each agent that is to be dispensed from the applicator.

In some examples, the 3D printing system 102 may also include a radiation source (not shown). The radiation source may be used to expose the build area platform 104 (and any build material 108 and/or agent(s) thereon) to energy (e.g., electromagnetic radiation) that ultimately fuses and/or sinters the build material 108 (e.g., that is in contact with a fusing agent).

The radiation source may be any suitable fusing lamp, examples of which include commercially available infrared (IR) lamps, ultraviolet (UV) lamps, flash lamps, and halogen lamps. Other examples of the radiation source may include microwave radiation sources, xenon pulse lamps, IR lasers, etc. In some examples, the radiation source may be a stationary lamp or a moving lamp. The stationary lamp may be in a fixed position relative to the build area platform 104, and may be turned on when radiation exposure is desired and off when radiation exposure is not desired. The moving lamp(s) can be mounted on a track (e.g., a translational carriage) to move across the build area platform 104, e.g., along the y-axis. This allows for printing and heating in a single pass. Such lamps can make multiple passes over the build area platform 104 depending on the amount of exposure utilized in the method (s) disclosed herein.

Each of these physical elements may be operatively connected to a controller 120 of the 3D printing system 102. The controller 120 may control the operations of the build area platform 104, the build material supply 107, and the build material distributor 110. As an example, the controller 120 may control actuators (not shown) to control various operations of the 3D printing system 102 components. The controller 120 may be a computing device, a semiconductor-based microprocessor, a central processing unit (CPU), an application specific integrated circuit (ASIC), and/or another hardware device. Although not shown, the controller 120 may be connected to the 3D printing system 102 components via communication lines.

The controller 120 manipulates and transforms data, which may be represented as physical (electronic) quantities within the 3D printing system's registers and memories, to control the physical elements to create the 3D object 118. As such, the controller 120 is depicted as being in communication with a data store 122. The data store 122 may include data pertaining to a lattice anchor 116 and a 3D object 118 to be printed by the 3D printing system 102. The data for the selective delivery/application of the build material 108 may be derived from a model of the lattice anchor 116 and the 3D object 118 to be formed. For instance, the data may include the order in which the agents are to be printed and the locations on each layer of build material 108 that the agents are to be deposited. The data store 122 may also include machine readable instructions (stored on a non-transitory computer readable medium) that are to cause the controller 120 to control the amount of build material 108 that is supplied by the build material supply 107, the movement of the build area platform 104, the movement of the build material distributor 110, etc.

In some examples, the data store 122 may include computer executable instructions to cause the controller 120 to utilize the build material distributor 110 to dispense the build material 108 to form a lattice anchor 116 in the powder bed 114 of the 3D printing system 102. As used herein, the term “powder bed” refers to build material 108 that is deposited on the build area platform 104 and contained within side walls of the 3D printing system 102. The lattice anchor 116 and the 3D object 118 may be formed within the powder bed 114

As discussed above, with powder bed fusion technologies (e.g., MJF, laser sintering, etc.) some build material 108 may experience a poor interaction with the build material distributor 110. For example, the melt pool of some types of build material 108 may stick to the build material distributor 110, may be pulled by the build material distributor 110, or may be pushed by the build material distributor 110 during the layer-by-layer printing process. In some cases, the print may fail completely or the geometry of printed 3D object 118 may fail specifications or quality control evaluations. To eliminate or minimize the effects of the poor interaction of the build material 108 with the build material distributor 110, a lattice anchor 116 may be printed within the powder bed 114 prior to printing a 3D object 118. In some examples, the lattice anchor 116 may counteract the 3D object 118 part being pushed by the build material distributor 110. In some examples, the lattice anchor 116 may be printed in a layer of the powder bed 114 that is above the surface of the build area platform 104. In this case, powdered build material 108 may be located below the lattice anchor 116. In some examples, the lattice anchor 116 may be printed on the build area platform 104.

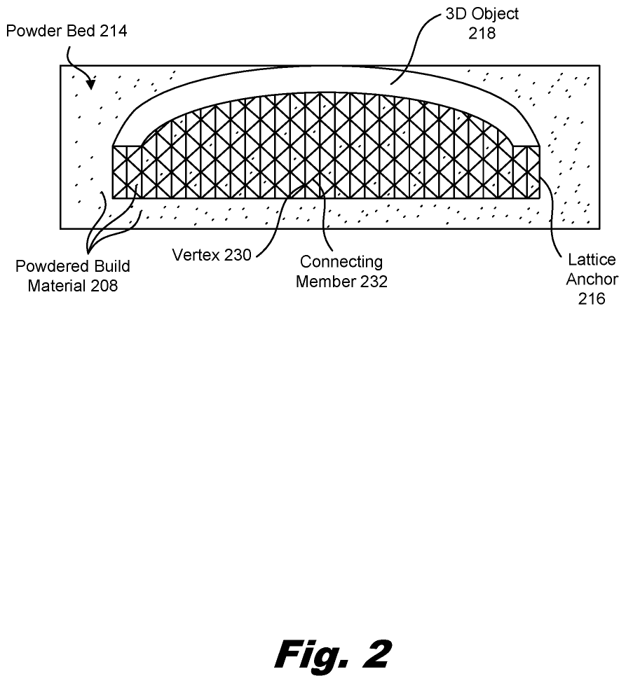

In some examples, the lattice anchor 116 may include a 3D mesh that has a plurality of interconnecting members. An example of a lattice anchor 116 attached to a 3D object 118 is illustrated in FIG. 2.

Referring momentarily to FIG. 2, the lattice anchor 216 is formed in a powder bed 214 below the 3D object 218. In this example, the lattice anchor 216 is the powder bed 214 a number of layers above the build area platform.

The lattice anchor 216 may be formed by a number of connecting members 232 that meet at a point (referred to as a vertex 230). The lattice anchor 216 may include a number of vertices 230 dispersed in 3D space where the vertices 230 connect to a number of connecting members 232.

The lattice anchor 216 may have different geometries. In the example of FIG. 2, the lattice anchor 216 has a repeating, uniform geometry formed by triangles. While the example of FIG. 2 is shown in two dimensions, it should be noted that the vertices 230 of the lattice anchor 216 may extend in 3D to form a 3D mesh. Other examples of lattice anchor geometry include hexagonal, rectangular, etc.). In some examples, the lattice anchor 116 may have a varying (e.g., random, non-uniform) geometry.

In some examples, the connecting members 232 may have a given cross-sectional geometry. For example, the connecting members 232 may have a square, rectangular, or circular cross section. The cross-section area of the connecting members 232 may be minimized to reduce the amount of interaction that the lattice anchor 216 has with the build material distributor (e.g., FIG. 1, 110). Furthermore, the length and cross-sectional area of the connecting members 232 may be sized to trap powdered build material 208 within the lattice anchor 216 while providing structural strength to resist forces applied to the 3D object 218 by the build material distributor.

Returning to FIG. 1, the lattice anchor 116 may be formed at a depth within the powder bed 114 to secure the lattice anchor 116 in the powder bed 114. This anchor depth may vary based on the properties of the 3D object 118. For example, the anchor depth may vary based on the material of the build material 108, the size of the cross-sectional area of the 3D object 118, the temperature gradient of the melt pool of the 3D object 118, etc. In some examples, the anchor depth may be 1 centimeter (cm) or more below the bottom surface of the 3D object 118.

In some examples, the lattice anchor 116 may be used when the layer cross-sectional area of the 3D object 118 is above a threshold. For example, if the cross-sectional area of the 3D object 118 is less than a threshold, then the 3D object 118 may be printed without the lattice anchor 116. However, if the cross-sectional area of the 3D object 118 is equal to or greater than the threshold surface area, the lattice anchor 116 may be used to anchor the 3D object 118 in the powder bed 114.

In some examples, multiple lattice anchors 116 may be attached to the 3D object 118. For example, lattice anchors 116 may be added to locations that tend to stick to the build material distributor 110 causing deformation or failure of the 3D object 118. For instance, edges and corners may tend to be deformed by sticking to the build material distributor 110 more than interior surfaces of the 3D object 118. Therefore, lattice anchors 116 may be added to corners and edges (e.g., external sides) of the 3D object 118 while the interior surfaces of the 3D object 118 may not include lattice anchors 116.

In some examples, the lattice anchor 116 may be attached to a portion of the 3D object 118 that is prone to deform due to interaction of the 3D object 118 with a build material distributor 110. As described above, a corner or edge may tend to experience more deformation due to the 3D object 118 sticking to the build material distributor 110 as compared to interior surfaces of the 3D object 118. Thus, a lattice anchor 116 may be printed on a portion (e.g., corner, edge, etc.) that is prone to deformation due to interaction of the 3D object 118 with a build material distributor 110. In this case, other portion(s) of the 3D object 118 may be formed without a lattice anchor 116 attached to the bottom surface of these other portion(s).

The lattice anchor 116 may be formed by print layers having a small cross-sectional area to produce a part that is well anchored in the powder bed 114 and has little to no interaction with the build material distributor 110. For example, the orientation of the connecting members of the lattice anchor 116 may be angled such that for a given print layer, the cross-sectional area of the lattice anchor 116 is minimal. Thus, the lattice anchor 116 may be formed from a number of vertical or angled connecting members as opposed to horizontal connecting members, which would have a larger cross-sectional area for the build material distributor 110 to stick.

In some examples, openings in the lattice anchor 116 may be sized to minimize interaction of the lattice anchor 216 with a build material distributor of the 3D printing system. For example, the vertices of the connecting members in the lattice anchor 116 may be spaced apart from each other to prevent or reduce the build material distributor 110 from sticking to the lattice anchor 116. The lattice anchor 116 is to avoid sticking to the build material distributor 110 due to the low cross-sectional layer surface area of the connecting members of the lattice anchor 116.

In some examples, the data store 122 may include computer executable instructions to cause the controller 120 to utilize the build material distributor 110 to dispense the build material 108 to form the 3D object 118 attached to the lattice anchor 116. The lattice anchor 116 and the 3D object 118 may be formed in a plurality of layers of build material 108. In some examples, a 3D object 118 with a large cross-sectional layer surface area may be attached to the top of the lattice anchor 116.

The lattice anchor 116 may resist movement of the 3D object 118 by the build material distributor 110 during forming of the 3D object 118. For example, the lattice anchor 116 may counter a force exerted on the 3D object 118 by the build material distributor 110 during forming of the 3D object 118. For instance, as the build material distributor 110 spreads the build material 108 for a layer of the 3D object 118, the build material 108 may stick to the build material distributor 110. This sticking of the build material 108 to the build material distributor 110 may exert a lateral force (e.g., side push) or a vertical force (e.g., a pulling force) on the 3D object 118. However, because the lattice anchor 116 was formed within the powder bed 114, the lattice anchor 116 may counter the forces exerted on the 3D object 118 by the build material distributor 110 during forming of the 3D object 118.

After printing is complete, the 3D object 118 may be removed from the powder bed 114. The 3D object 118 may be cleaned (e.g., using sandblasting). In some examples, the lattice anchor 116 may be removed from the 3D object 118. For example, a mechanical device (e.g., a wire cutter, saw, mill, etc.) may be used to detach the lattice anchor 116 from the 3D object 118.

In an example of the printing process, a 3D model (also referred to as a 3D design file) for the 3D object 118 may be formed by combining a 3D model of a lattice anchor 116 with the 3D model of the 3D object. The combined model (i.e., the combined lattice anchor model and 3D object model) may be sliced using a slicer into individual layer images to be printed.

The slices may be printed in a layer-by-layer manner using the 3D printing system 102 (e.g., an MJF 3D printer). In some examples, the printing process may start with heating the powder bed 114, rolling out a layer of build material 108, jetting agents for a slice using the slice data of the lattice anchor 116, fusing this layer and then repeating this process until the lattice anchor 116 is formed in the powder bed 114. After a portion of the lattice anchor 116 is formed, the 3D object 118 may begin printing, attached to this lattice anchor 116. The 3D object 118 that would tend to be moved around in the powder bed 114 due to poor interaction of the build material 108 and the build material distributor 110 may be held in place due to the buried lattice anchor 116 providing an anchor stability support.

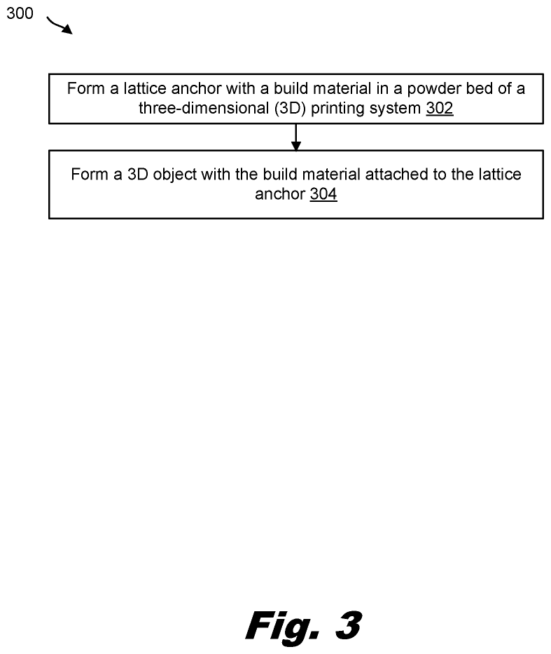

FIG. 3 is a flow diagram illustrating a method 300 for forming a lattice anchor for a 3D object, according to an example. In some examples, the method 300 may be performed by a 3D printing system, such as the 3D printing system 102 of FIG. 1.

At 302, a lattice anchor may be formed with a build material in a powder bed of the 3D printing system. The lattice anchor may include an open mesh of a plurality of connecting members. Openings in the lattice anchor may be sized to minimize interaction of the lattice anchor with a build material distributor of the 3D printing system. In some examples, the lattice anchor may be formed at a depth within the powder bed to secure the lattice anchor in the powder bed. For example, the depth of the lattice anchor may be approximately 1 cm below the 3D object in the powder bed.

At 304, the 3D object may be formed with the build material attached to the lattice anchor. For example, the build material distributor of the 3D printing system may deposit build material in a layer of the powder bed such that the 3D object connects to the lattice anchor. The lattice anchor may resist movement of the 3D object by the build material distributor during forming of the 3D object. For example, the lattice anchor may counter a force exerted on the 3D object by the build material distributor during forming of the 3D object.

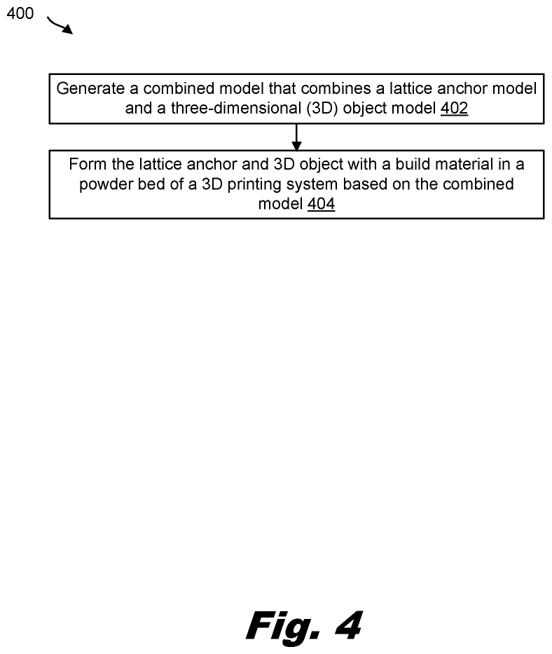

FIG. 4 is a flow diagram illustrating a method 400 for designing a lattice anchor for a 3D object, according to an example. In some examples, the method 400 may be performed by a 3D printing system, such as the 3D printing system 102 of FIG. 1. In some examples, the method 400, or portions of the method 400, may be performed by a computing device separate from a 3D printing system.

At 402, a combined model may be generated that combines a lattice anchor model and a 3D object model. For example, the 3D object model may be a 3D design file for a 3D object that is to be printed by a 3D printing system. The lattice anchor model may be a digital representation of a lattice anchor that is to be printed by the 3D printing system.

The lattice anchor model may be merged with the 3D object model such that the lattice anchor connects to the 3D object and the lattice anchor is to be printed before the 3D object. For example, the 3D object model may be positioned on top of the lattice anchor model with respect to the powder bed of the 3D printing system. Thus, the lattice anchor may project below the 3D object into the powder bed upon printing of the lattice anchor and 3D object.

In some examples, combining the lattice anchor model with the 3D object model may be based on whether the cross-sectional layer surface area of the 3D object model is greater than a threshold surface area. For example, the threshold surface area may be based on a surface area of the 3D object that is likely to stick to the build material distributor. The method 400 may include determining that the cross-sectional layer surface area of the 3D object model is greater than a threshold surface area. In this case, the method 400 may include generating the lattice anchor model (e.g., a 3D model of the lattice anchor) in response to determining that the cross-sectional layer surface area of the 3D object model is greater than the threshold surface area. In some examples, generating the lattice anchor model may include digitally creating a 3D model of the lattice anchor. In some examples, generating the lattice anchor model may include retrieving a 3D model of the lattice anchor from a database and sizing the retrieved lattice anchor model to fit the 3D object model.

In some examples, the combined model may be sliced to generate a layer sequence. For example, the digital file that includes the combined lattice anchor model and the 3D object model may be digitally sliced into discrete layers that are to be printed by the 3D printing system.

At 404, the lattice anchor and 3D object may be formed with a build material in a powder bed of a 3D printing system based on the combined model. For example, the layer sequence of the combined model may be loaded into memory of the 3D printing system. The lattice anchor and 3D object may be formed (e.g., printed) based on the layer sequence. In some examples, forming the lattice anchor and 3D object may include distributing build material with the build material distributor of the 3D printing system.

1. A method, comprising:
forming a lattice anchor with a build material in a powder bed of a three-dimensional (3D) printing system; and
forming a 3D object with the build material attached to the lattice anchor.

2. The method of claim 1, wherein the lattice anchor comprises an open mesh of a plurality of connecting members.

3. The method of claim 1, wherein the lattice anchor is formed at a depth within the powder bed to secure the lattice anchor in the powder bed.

4. The method of claim 1, wherein the lattice anchor is attached to a portion of the 3D object that is prone to deform due to interaction of the 3D object with a build material distributor.

5. The method of claim 1, further comprising:
removing the lattice anchor from the 3D object.

6. The method of claim 1, wherein openings in the lattice anchor are sized to minimize interaction of the lattice anchor with a build material distributor of the 3D printing system.

7. The method of claim 1, wherein the lattice anchor is to resist movement of the 3D object by a build material distributor during forming of the 3D object.

8. The method of claim 7, wherein the lattice anchor is to counter a force exerted on the 3D object by the build material distributor during forming of the 3D object.

9. A method, comprising:
generating a combined model that combines a lattice anchor model and a three-dimensional (3D) object model; and
forming a lattice anchor and a 3D object with a build material in a powder bed of a 3D printing system based on the combined model.

10. The method of claim 9, wherein the 3D object model is positioned on top of the lattice anchor model with respect to the powder bed of the 3D printing system.

11. The method of claim 9, further comprising:
slicing the combined model to generate a layer sequence; and
forming the lattice anchor and 3D object based on the layer sequence.

12. The method of claim 9, further comprising:
determining that a cross-sectional layer surface area of the 3D object model is greater than a threshold surface area; and
generating the lattice anchor model in response to determining that the cross-sectional layer surface area of the 3D object model is greater than the threshold surface area.

13. A three-dimensional (3D) printing system, comprising:
a build material distributor;
a controller; and
a non-transitory computer readable medium having stored thereon computer executable instructions to cause the controller to:
utilize the build material distributor to dispense the build material to form a lattice anchor; and
utilize the build material distributor to dispense the build material to form a 3D object attached to the lattice anchor, the lattice anchor and 3D object being formed in a plurality of layers.

14. The 3D printing system of claim 13, wherein the build material comprises a polypropylene powder.

15. The 3D printing system of claim 13, wherein the lattice anchor is to avoid sticking to the build material distributor due to a low cross-sectional layer surface area of the lattice anchor.
